(19) United States
(12) Patent Application Publication
(10) Pub. No.: US 2011/0277842 A1
(43) Pub. Date: Nov. 17, 2011

(54) EcoSafe Desal Brine Return System

(76) Inventor: Benjamin Blumenthal, Atlanta, GA (US)

(21) Appl. No.: 12/781,385

(22) Filed: May 17, 2010

(51) Int. Cl. B60P 3/22

(52) U.S. Cl. 137/1; 137/899

(57) ABSTRACT

Described is a system for allowing ecologically-sensitive return of brine to seawater. A plurality of “smart” hoses is employed with riptide and sun light sensors so as to allow for returning concentrated brine to as large a volume of sea water as possible. Return hoses may include elements to allow for control of their depth and location for optimal safe brine release.

### FIELD AND BACKGROUND OF THE INVENTION

The present invention relates to the field of high-volume brine dispersal in general and desalination water effluent management in particular.

Drinking water is a precious commodity. Throughout the world, drought, urban overexpansion and lack of rain have contributed to significant shortages of drinkable water. Cities such as Atlanta and countries such as Israel have watched as their natural water resources have diminished dramatically in light of high demand and modest precipitation. The United Nations World Health Organization (WHO) estimates that even under normal rainfall conditions, one billion people lack access to safe drinking water and expects that two out of every three people will be living with water shortages by 2025. There clearly is a need for reliable alternative sources of drinking water for both developed and underdeveloped countries.

As the Earth is 70% covered by water, the obvious solution would be to transform undrinkable seawater into potable water. Seawater “as is” is dangerous for consumption and large quantities can lead to serious health issues with changes in cellular osmotic pressure. Desalination, the process by which seawater is cleaned of its high salt content, is not a new concept. Desalination plants have been active in various parts of the world for fifty years and most naval and commercial ships have produced onboard drinking water through desalination since World War II. While there are more than 1,500 desalination plants in the world, desalinated water provides only a small fraction of the world's available fresh water supply. The question is why. There are several reasons.
(1) Desalinated water is not cheap. When one factors in the costs of building a facility, securing “beach-front” property near the seawater source and the energy required to drive reverse osmosis, distillation or other desalination processes, the cost of desalinated water is generally not competitive with water derived from lake or aquifer sources.
(2) Careless discharge of brine can make desalination an environmentally destructive process. Desalination generally leads to heating of both the product potable water as well as the waste brine. The latter is generally returned to the ocean. Brine can be devastating on sea flora and fauna. Returning brine in the general area of the intake pipes for a desalination plant can lead to more difficult and costly preparation of drinkable water due to the higher salt concentration in the source sea water.
(3) Desalination is generally a very local phenomenon. The location of a desalination plant defines the immediate reach of the final product drinking water due to the costs of piping such water long-distance. Alternative shipping or transport means are not economically feasible and as such desalination plants are very local in their contribution to totally available drinking water. This point was poignantly demonstrated when Israel signed a water purchase agreement with Turkey. Neither country could propose a cost-effective solution for transporting the inexpensive Turkish water to willing Israeli consumers.

One approach to overcome the issue of near-land return of concentrated brine has been to outfit a ship that could desalinate water and then dilute the brine into the surrounding sea in an environmentally safe far from the coastline. The advantages of a ship include flexibility in location as per need, responsiveness to disasters where drinking water is often one of the most urgent commodities, lower fixed costs due to an absence of ocean-front property for function, and stability in drinking water availability by adding to local resources as per specific demand and conditions. Though most sea-going vessels desalinate water for internal consumption, to date, there has never been a fleet of ocean-going vessels dedicated to desalinated water delivery in addition to disaster relief and electric power delivery.

The concept of a “floating desalination plant” has been discussed for years. Lampe, et al. describe a system for converting a retired oil tanker as a platform for Preussag reverse osmosis (Desalination 114: 145-151 [1997]). Gordon, et al in U.S. Pat. No. 7,081,205 and Gordon in U.S. Pat. Nos. 7,306,724, 7,476,323 & 7,510,658 describe systems for delivering desalinated water from a floating vessel. In their system they process the residual brine (“concentrate”) by mixing it with seawater to cool it and reduce its salt concentration prior to return of treated brine to the ocean. While their efforts may reduce the damage caused by the waste brine, they still return over-concentrated salts to the ocean and their vessel must have a significant volume set aside for mixing the millions of gallons of brine with sea water prior to ejection.

In U.S. Pat. No. 5,695,643 Brandt et al. teach a method of treating and disposing of waste water containing salt, such as the brine that results from production of oil and/or gas wells, which includes introducing the waste water into a reverse osmosis unit to produce concentrated brine, and passing the concentrated brine through a combustion heat evaporator wherein said combustion heat is generated in a submerged combustion evaporator or exhaust gases from an internal combustion engine to power a waste heat evaporator to produce a further concentrated brine. The concentrated brine from the combustion heat evaporator can then be mixed with a liquid such as the waste water that is introduced into the reverse osmosis unit. The resulting product can then be injected into a subterranean formation for purposes of disposal. The method allows the volume of the waste water to be significantly reduced while also increasing the salt concentration of the waste water. In other embodiments the reverse osmosis unit and the combustion heat evaporator are used individually. Alternatively, the concentrated brine from the combustion heat evaporator can be introduced into a dryer to evaporate water from the concentrated brine to produce low moisture salt particles.

U.S. Pat. No. 5,254,257 to Brigano, et al. teaches a method of purifying spent brine from the regeneration of ion exchange resin, for example resin in water softeners. The method comprises acidifying the spent brine to a pH of less than 3 with an acid other than sulfuric acid, which acid is preferably chosen from at least one acid which forms a calcium salt that is more water soluble than calcium sulfate. One passes the brine through a nanofiltration membrane to purify the brine by separating from it a waste stream which comprises the majority of the polyvalent ions present, so that the purified brine has most of its contaminating polyvalent ions removed.

### SUMMARY OF THE INVENTION

It is therefore an object of the present invention to provide a means for dispersing waste brine from a desalination facility so as to prevent ecological damage. Specifically, some embodiments of the present invention use a combination of systems to allow for rapid and wide-spread dispersal of concentrated brine returning to an ocean or similar body of water.

The invention includes a system for dispersing concentrated brine from a desalination facility in an environmentally responsible manner, including: a computer-based riptide detector; a water quality detector; a sunlight detector; a plurality of concentrated brine return hoses; and, a unit for directing the hoses to at least one riptide detected by the riptide detector and at a depth below the sun line as determined by the sunlight detector.

In one aspect of the system, the desalination facility is associated with a vessel.

In another aspect of the system, the plurality of hoses includes hoses of different lengths.

In another aspect of the system, the hoses include a plurality of holes for release of the concentrated brine over a large volume.

In another aspect of the system, the hoses include rotating heads that can deposit the brine in multiple locations.

In another aspect of the system, the at least one riptide moves water away from a predetermined coastal area.

In another aspect of the system, the riptide detector includes a sonar component.

The invention further includes a method for returning concentrated brine from a desalination facility in an environmentally responsible manner, including: detecting at least one riptide; moving brine dispersal hoses into proximity to the riptide; and, delivering the brine into the riptide, wherein the brine is quickly diluted and taken in a direction away from a predetermined coastal area.

In one aspect of the method, the desalination facility is associated with a vessel.

In another aspect of the method, the brine is returned to the riptide under the sun line.

In another aspect of the method, there is additionally the step of releasing the brine over a plurality of distances from the facility.

In another aspect of the method, there is additionally the step of adding compressed air to the brine prior to delivering the brine to the at least one riptide.

In another aspect of the method, the compressed air is used to press the brine through a plurality of hoses and into the at least one riptide.

In another aspect of the method, the hoses include a plurality of holes to allow for release of the brine over a large volume of water.

In another aspect of the method, there is an additional step of adjusting outfall trajectory in response to relevant ecological data.

The invention also includes a device for allowing for rapid dispersal of concentrated brine from a desalination facility including: a plurality of return hoses of different lengths having at least one transport element; and, compressed air, wherein the compressed air pushes waste brine through the hoses whose positions are controlled by the transport element.

In one aspect of the device, the distributor caps include a plurality of holes for brine release.

In another aspect of the device, the hoses may be distributed from the facility in a plurality of compass directions.

In another aspect of the device, the at least one transport element is realized as a plurality of transport elements.

In another aspect of the device, the facility is associated with a vessel.

In another aspect of the device, the return hoses include sensors for measuring salinity in the location where brine is returned.

### BRIEF DESCRIPTION OF THE DRAWINGS

With specific reference now to the drawings in detail, it is stressed that the particulars shown are by way of example and for the purposes of illustrative discussion of the preferred embodiment of the present invention only, and are presented in the cause of providing what is believed to be the most useful and readily understood description of the principles and conceptual aspects of the invention. In this regard, no attempt is made to show structural details of the invention in more detail that is necessary for a fundamental understanding of the invention, the description taken with the drawings making apparent to those skilled in the art how the several forms of the invention may be embodied in practice.

In the drawings:

FIG. 1 shows a schematic view of a system for delivering waste brine to a riptide from a vessel-based facility;

FIG. 2 shows a schematic view of a system for delivering waste brine to a riptide from a land-based facility;

FIG. 3 shows schematic views of brine return hoses;

FIG. 4 shows a schematic view of a brine return strategy for a floating desalination plant;

FIG. 5 shows a schematic view of a brine hose having a “distributor cap” for release of waste brine in multiple directions; and,

FIG. 6 shows a flowchart for a method of the present invention.

### DETAILED DESCRIPTION OF EMBODIMENTS

### Description of the Preferred Embodiment

In the following description, numerous specific details are set forth in order to provide a thorough understanding of the present invention. It will be apparent, however, to one skilled in the art that the present invention may be practiced without these specific details. In other instances, well-known circuits and control logic have not been shown in detail in order not to unnecessarily obscure the present invention. The following definitions are for aiding in understanding the present invention.

### DEFINITIONS

Certain terms are now defined in order to facilitate better understanding of the present invention.

Many terms will have their generally accepted meanings within the context of the present invention. “Desalination”, “brine”, and other desalination-related terms may take their generally understood meanings. “GPS”, “motor” and “transceiver” may have their normal meanings as understood in the electrical and physical arts.

“Riptide” may have its generally understood meaning and for the present invention refers to a riptide, also called rip current, as a strong channel of water, either on the surface or underwater, that flows seaward from the shoreline.

“Outfall” may generally refer to concentrated brine that is returned to the sea from a desalination process. “Outfall trajectory” may refer to the direction of release of brine back to a body of water.

“Ecological data” may refer to information including but not limited to salinity, sunlight, temperature, wildlife presence and other data that may affect the location of outfall release.

“Transport element” may refer to components that allow for human or computer control over the movement and/or direction of a “return hose”, a hose or the like used to return concentrated brine to the sea. Transport element may include motors, GPS transceivers and other elements that allow for placing the return hoses in optimal positions for minimal environmental damage.

One of the greatest technical and ecological problems with large-scale desalination is the return of highly concentrated (hot) brine back to the ocean from which source water is taken. Marine habitat tends to have very sensitive balances between environment and flora and fauna living off of and in this environment. Hot or warm concentrated salt water returned in huge quantities is generally an environmental disaster. Just as nothing beyond some unique strains of bacteria can live in the Dead Sea, so the microenvironment into which brine is returned into the sea can be damaged to the point of no longer supporting the native habitat. Such loss is not just a shame—it can have severe adverse effects on fish populations and the usefulness of oceans for human livelihood and well-being.

The present invention includes a combination of elements and strategies to allow for disbursement of concentrated desalination brine product away from shores and in a manner that allows for the most rapid dilution of the material. As one expands the volume of sea water into which the brine is returned, one reduces the overall local concentration of the salts in the location of return.

### First Embodiment

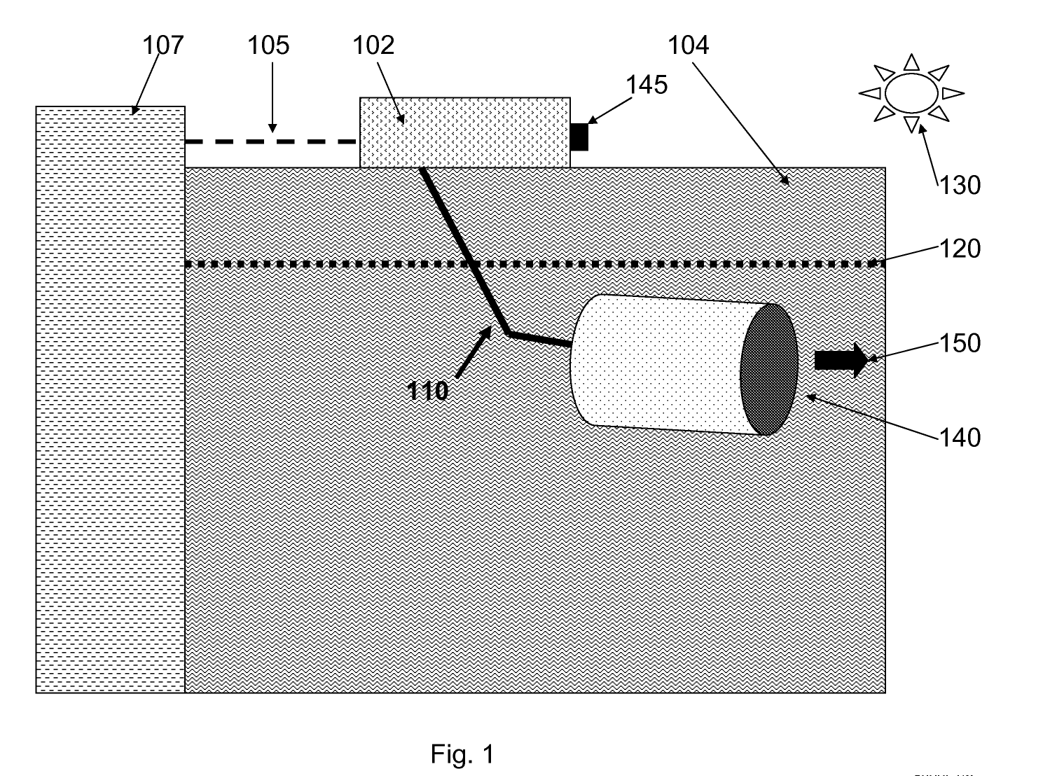

Attention is turned to FIG. 1, which shows a schematic representation of an embodiment of the present invention. Shown in FIG. 1 is a floating desalination facility 102 located in a salty body of water 104 at some distance 105 from land 107. On the one hand, the facility 102 should be close to land 107, so as to minimize travel of potable water from the facility 102 to inhabitants in need of said water. On the other hand, one would wish to have returned concentrated brine be as far away from land 107 as possible so as to avoid contamination of the land's coastline with the brine outfall. In order to achieve this balance, the facility 102 is generally located at a distance 105 a few kilometres from land 107 and brine return hoses 110 are directed away from land 107 and may have lengths themselves of several kilometers.

In order to further reduce the environmental impact of brine release from the desalination facility 102, the return hoses are directed beneath the sun line 120. The sun line 120 represents the lowest depth at which sun 130 light penetrates a body of water. Returning brine beneath the sun line aids in cooling of the returned brine and also helps to reduce the environmental impact of the brine on the local marine habitat. The return hoses 110 may include sensors (not shown for purposes of clarity) to monitor the quality of the water surrounding the outfall, that sends said data to a central computer capable of directing small motors, GPS elements, a transceiver, and/or weights (not shown) at the end of the return hoses 110 in order to allow for their controlled movement to a desired depth and compass direction.

Additionally, in one aspect of the present invention, a riptide 140 is identified by a riptide sensor (shown as a unique element for clarity only; it may be part of a computer or other elements, not shown), that is optionally associated with the facility 102. The riptide sensor 145 may be onboard the facility 102 or integrated into the return hoses 110. The riptide sensor 145 identifies a riptide 140 that is heading away 150 from land 107 and can direct return hoses 110 automatically or through mechanical means into the area of the riptide 140. This capability allows for rapid distribution and dilution of brine returned to sea from a desalination facility 102 or other element that produces and returns highly concentrated salt water.

### Second Embodiment

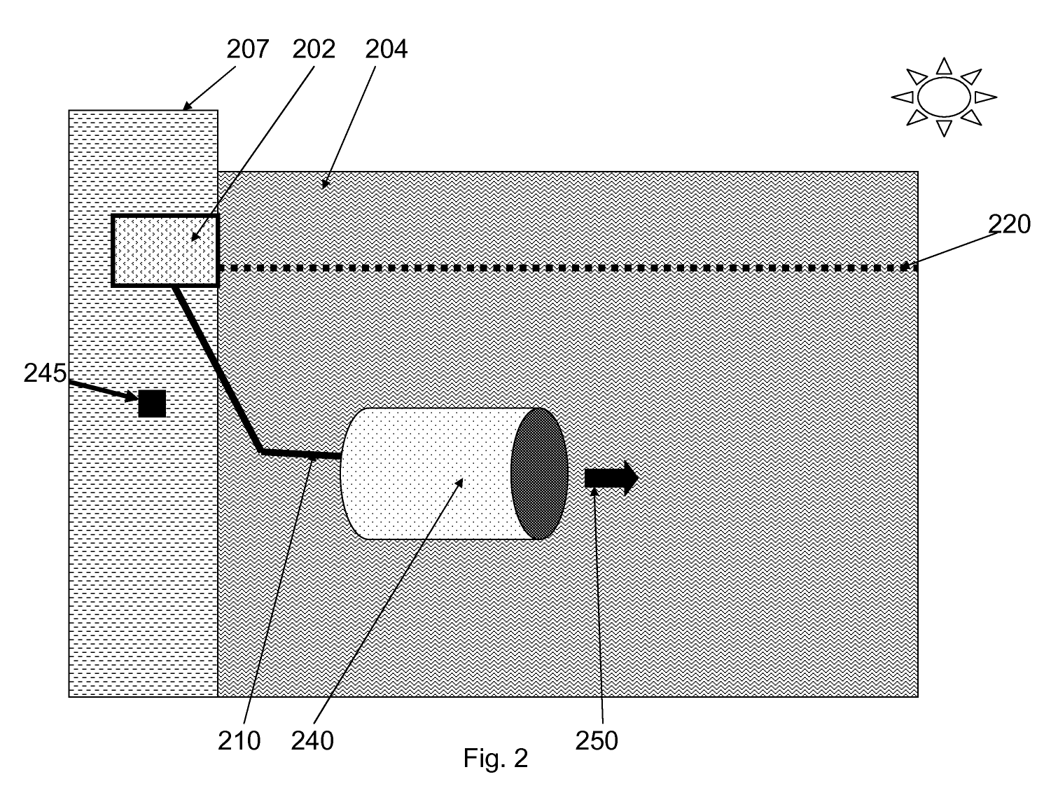

Attention is now turned to FIG. 2 which shows an alternative embodiment of the present invention. Similar elements are advanced by 100 from their corresponding elements in FIG. 1. A land-based desalination facility 202 is located on land 207 in proximity to a large body of water 204. Water is brought into the plant and converted to drinking water and highly concentrated brine waste. The brine waste is returned to the body of water 204 through the agencies of return hoses 210 that can be controlled by either computers or humans as to location, direction and depth. The return hoses 210 are placed at a distance that may reach several kilometers between the facility 202 and the end of the return hoses 210. The hoses are generally placed below the sun line 220 and may be controlled by motors, GPS units, transceivers or other elements to control their precise position. Additionally, a riptide sensor 245 that may be associated with the facility 202, the return hoses 210, or separately situated on land 207 (as shown) may be used to locate at least one riptide 240 heading away 250 from land 207, into which return hoses 210 can be directed. By delivering hot or warm, concentrated brine into a riptide 240, the present invention allows for rapid dispersal of concentrated brine into a very large volume of water. And as such, the amount of potential damage of the marine habitat near a desalination facility 202 is accordingly reduced.

### Third Embodiment

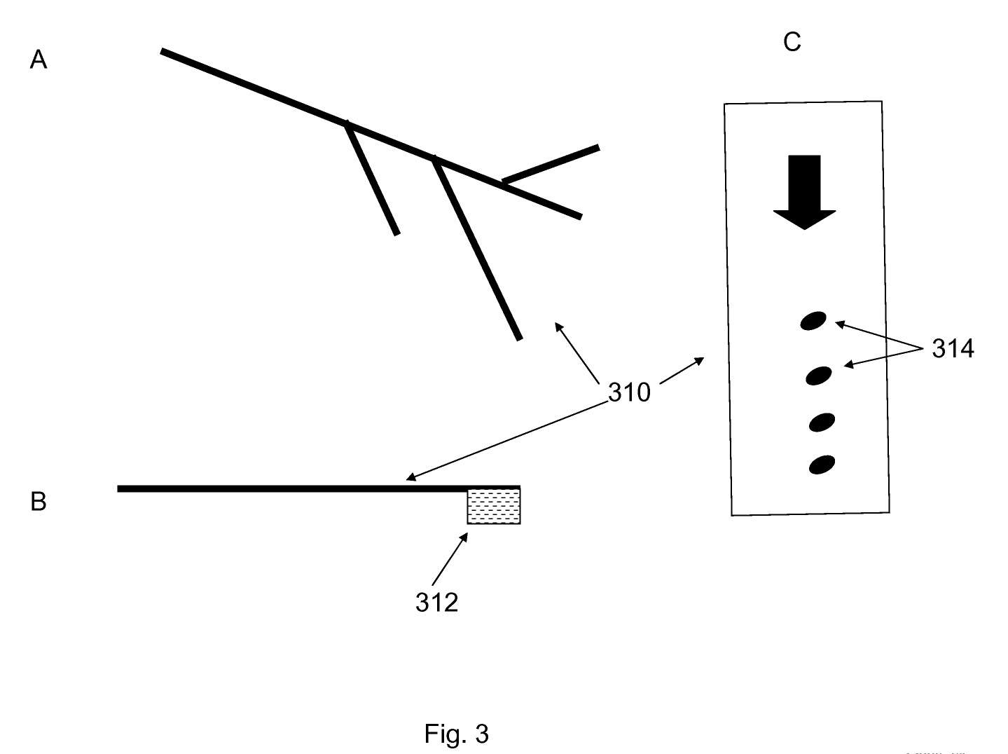

Attention is turned to FIG. 3 which shows different potential aspects of return hoses 310 as they are used in the present invention. Desalination initially requires an influx of sea or brackish water. The water is then converted to potable water, with the remainder being a very concentrated (and obviously undrinkable) brine solution. One does not wish to release brine close to a desalination facility for two reasons. The first is that the starting water will have an ever increasing salt concentration and thus make drinking water preparation that much more energy intensive. The second is that the release of brine near the facility—especially for land-based desalination plants—results in the destruction of the marine habitat near the facility. One thus wishes to transport the problematic brine far away from facility in which it is produced. In order to do so, hoses or pipes are generally employed. The hoses 310 may be kilometers in length and may be prepared from any relevant materials. Their diameters and the number of hoses used generally reflect that amount of waste brine—which could easily be in the tons/second regimen—produced.

FIG. 3A shows a return hose 310 that is a plurality of return hoses. The hoses may be separate or may branch from a single hose as is shown if this figure. The branch hoses may have different lengths and/or orientations so as to affect the most successful dilution of brine returning to the ocean or similar body of water. FIG. 3B shows a return hose 310 that includes a transport element 312. The transport element may include small motors, flotation elements, GPS transceiver, a radio control unit, and other components. The transport element allows a user or a computerized system to direct the return hose 310 to a specific direction, depth and location for brine return. As such, a return hose 310 can be directed towards a riptide or other location so as to allow for optimal brine return to ocean. FIG. 3C shows a close-up of the end of a return hose 310 in which a plurality of holes 314 allow for rapid brine release over an extended distance (based on the spacing of the holes).

Compressed air or other gases (such as nitrogen) could be used to help push brine through the return hoses 310. Compressed air (not shown) would increase the rate of brine release and the rate of mixing with bulk sea water and would thus reduce its toxicity to the environment. Return hoses 310 could also include (sensors) that measure salinity, depth, temperature or other features so as to aid in proper control of brine return.

### Fourth Embodiment

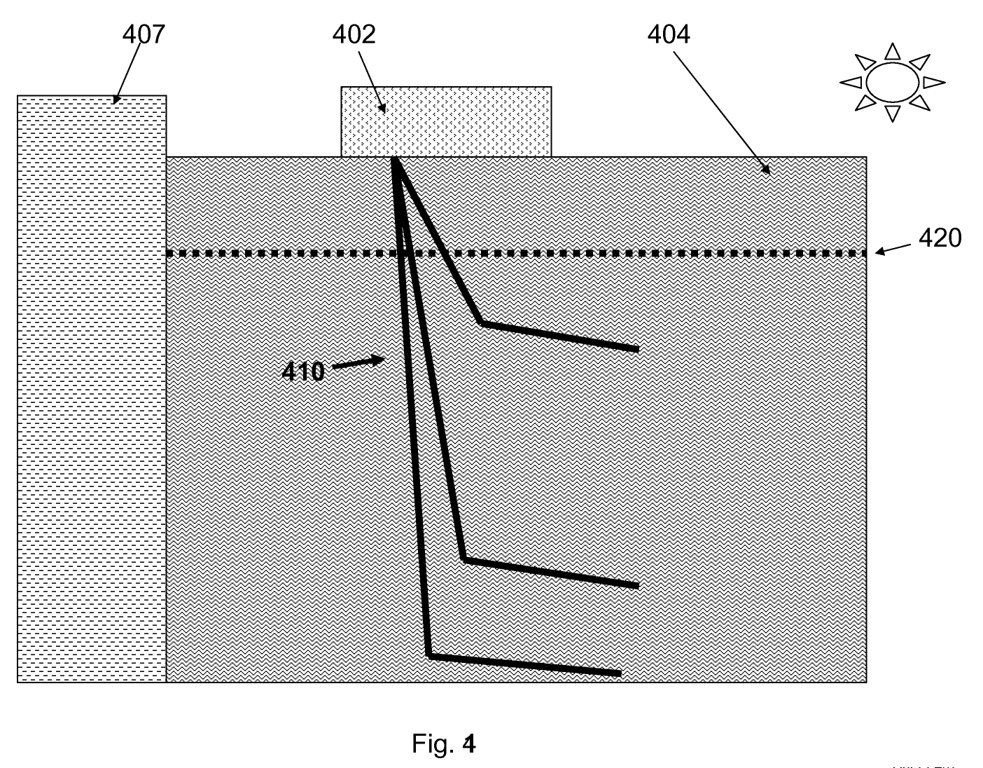

Attention is now turned to FIG. 4, which shows an additional strategy for releasing large volumes of concentrated brine in as environmentally-friendly manner as possible. A plurality of return hoses 410 leave a floating desalination facility 402 and are deployed at a plurality of depths, as shown. All return hoses are deployed beneath the sun line 420 and are spaced so as to create the largest possible volume into which to dilute the return brine. If one returns millions of gallons of concentrated brine into billions of gallons of normal sea water (generally at half the salt concentration as the brine waste), then the dilution of brine back to acceptable salt levels is faster and better for the local marine habitat.

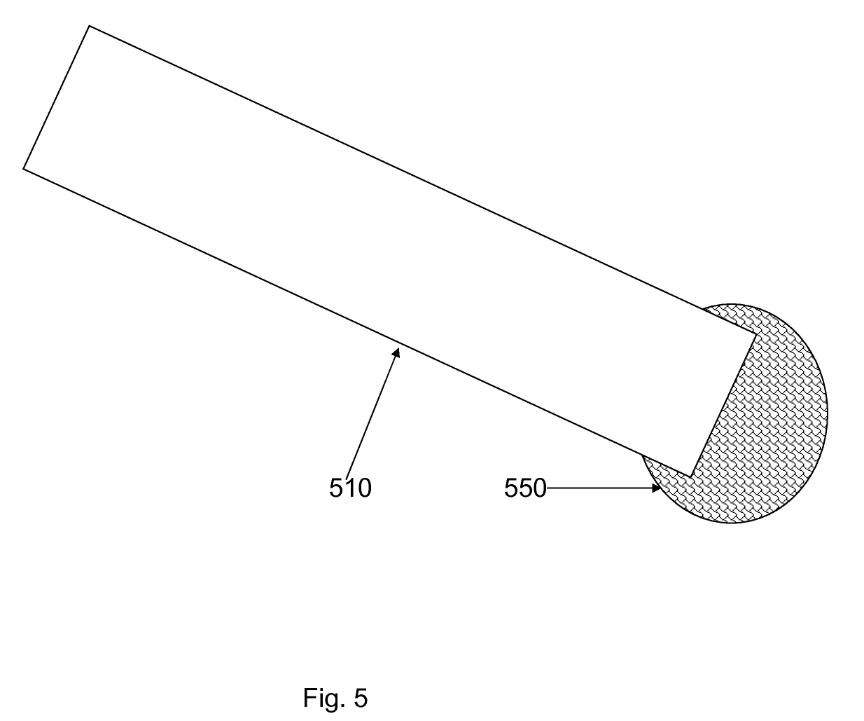

Attention is turned to FIG. 5 which shows the end of a return hose 510, which includes a distributor cap 550. The cap allows for multi-direction return of brine to source water as well as for the ability to rotate the cap 550 and thus allow for return of brine to a plurality of directions—and thus faster dissolution in water.

### Fifth Embodiment

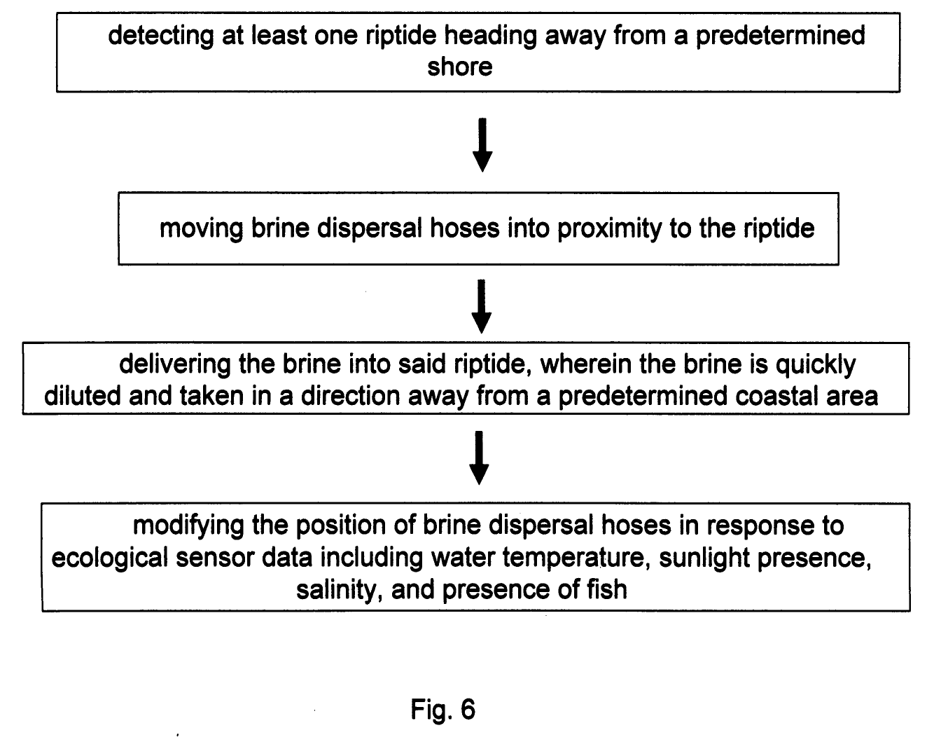

Attention is turned to FIG. 6, which shows a flowchart of a method of the invention. The embodiment includes the following: detecting at least one riptide heading away from a predetermined shore moving brine dispersal hoses into proximity to the riptide; delivering the brine into said riptide, wherein the brine is quickly diluted and taken in a direction away from a predetermined coastal area; and, modifying the position of brine dispersal hoses in response to ecological sensor data including water temperature, sunlight presence, salinity, and presence of fish.

### Some Benefits of the Use of the Present Invention

The usefulness of the present system is typically evident in the following ways:
a) The present invention aids in the rapid and ecologically-safe return of brine to an marine habitat.
b) Release of brine to riptides and/or through a plurality of controlled return hoses means that brine can be returned in a manner that shields the coastal areas from the harmful impact of localized brine outfall and dilutes said brine over a larger volume, thus diluting the brine more quickly.
c) The embodiments herewith described have application both for land-based as well as vessel-based desalination and other brine-producing facilities.
d) The invention allows for control of return hoses so as to return brine in a controlled and effective manner. Brine is returned at depths and in locations that can be tailored to the local environment.

An additional aspect of the systems and embodiments herewith described includes shooting a portion of the waste brine into the air either in the vicinity of the vessel or at some predetermined distance. Such a process offers several advantages. Firstly, the brine would cool in the air prior to its entry into the water. Secondly, the brine could be shot out over a very large area of the water in which desalination is taking place. Finally, under proper conditions, some or all of the brine shot airwards could be made into a mist that stays in the air and actually does not return to the water. The brine would be blown far from the site of desalination and thus create a situation of minimum environmental damage in the area of desalination. This spraying brine over the surface of the water closely mimics the natural evaporative phase of the hydrologic cycle wherein water evaporates off the oceans surface leaving the salt behind.

It will be appreciated by persons skilled in the art that the present invention is not limited to what has been particularly shown and described hereinabove. Rather, the scope of the present invention is defined by the appended claims and includes both combinations and sub-combinations of the various features described hereinabove as well as variations and modifications thereof which would occur to persons skilled in the art upon reading the foregoing description. Accordingly, it is intended to embrace all such alternatives, modifications and variations that fall within the scope of the appended claims.

1. A system for dispersing concentrated brine from a desalination facility in an environmentally responsible manner, including:
a computer-based riptide detector;
a sunlight detector;
a water quality detector;
a plurality of concentrated brine return hoses; and,
a unit for directing said hoses to at least one riptide detected by said riptide detector and at a depth below the sun line as determined by said sunlight detector.

2. The system according to claim 1, wherein said desalination facility is associated with a vessel.

3. The system according to claim 1, wherein said plurality of hoses includes hoses of different lengths.

4. The system according to claim 1, wherein said hoses include a plurality of holes for release of said concentrated brine over a large volume.

5. The system according to claim 1, wherein said hoses include distributor caps that can deposit said brine in multiple locations.

6. The system according to claim 1, wherein said at least one riptide moves water away from a predetermined coastal area.

7. The system according to claim 1, wherein said hoses include a transport element to allow for deploying said hoses at predetermined depth and location.

8. A method for returning concentrated brine from a desalination facility in an environmentally responsible manner, including:
detecting at least one riptide;
moving brine dispersal hoses into proximity to said riptide; and,
delivering said brine into said riptide, wherein said brine is quickly diluted and taken in a direction away from a predetermined coastal area.

9. The method according to claim 8, wherein said desalination facility is associated with a vessel.

10. The method according to claim 8, wherein said brine is returned to said riptide under the sun line.

11. The method according to claim 8, further including the step of releasing said brine over a plurality of distances from said facility.

12. The method according to claim 8, further including the step of adding compressed air to said brine prior to delivering said brine to said at least one riptide.

13. The method according to claim 12, wherein said compressed air is used to press said brine through a plurality of hoses and into said at least one riptide.

14. The method according to claim 13, wherein said hoses include a plurality of holes to allow for release of said brine over a large volume of water.

15. A device for allowing for rapid dispersal of concentrated brine from a desalination facility including:
a plurality of return hoses of different lengths having at least one transport element; and,
compressed air, wherein said compressed air pushes waste brine through said hoses whose positions are controlled by said transport element.

16. The device according to claim 15, wherein said distributor caps include a plurality of holes for brine release.

17. The device according to claim 15, wherein said hoses may be distributed from said facility in a plurality of compass directions.

18. The device according to claim 15, wherein said at least one transport element is realized as a plurality of transport elements.

19. The device according to claim 15, wherein said facility is associated with a vessel.

20. The device according to claim 15, wherein said return hoses include sensors for measuring salinity in the location where brine is returned.

21. The method according to claim 8, further including adjusting outfall trajectory in response to relevant ecological data.
